(19) United States
(12) Patent Application Publication
(10) Pub. No.: US 2005/0041848 A1
(43) Pub. Date: Feb. 24, 2005

(54) Method and system for detection of barrier core material in container preforms

(76) Inventors: Alan E. Thomas, Clearwater, FL (US); Michael C. Bagley, Palm Harbor, FL (US)

Correspondence Address: COHEN & GRIGSBY, P.C., 11 STANWIX STREET, 15TH FLOOR, PITTSBURGH, PA, 15222, US

(21) Appl. No.: 10/921,749

(22) Filed: Aug. 18, 2004

Related U.S. Application Data
(60) Provisional application No. 60/496,107, filed on Aug. 18, 2003.

(51) Int. Cl. G06K 9/00

(52) U.S. Cl. 382/141

(57) ABSTRACT

The invention provides a method and system for the real time, inspection of container preforms having a core barrier material therein. The system is operable to inspect the preform during the production process of the preform. The system is comprised of a process computer and a display output. A beam generator is used to generate a focused beam onto the preform. The preform will refract the beam. The refracted beam will be read and recorded by an image capture device. The image capture device will transmit refractive data to the process computer. The system is able then to generate an image corresponding to the inspected preform and the data related to the core barrier material is graphically represented as an area preferably having a geometric shape. The system then applies a mathematical function to the area to generate output that can used by the user for inspection purposes.

### CLAIM OF PRIORITY

This application claims priority to U.S. Provisional Application No. 60/496,107, which was filed on Aug. 18, 2003.

### FIELD OF THE INVENTION

The invention generally relates to the nondestructive analysis of multilayer barrier container preforms. More particularly, the invention relates to using an automated optical inspection system for optically inspecting the presence and characteristics of core barrier material in container preforms in real time, at manufacturing speeds, and without introducing more labor or scrap.

### BACKGROUND OF THE INVENTION

A critical component of container preforms, which are often PET preforms, is the barrier resin. The barrier resin is typically incorporated in PET preform as an intermediate layer or layers between PET. It is often important to determine the composition, thickness, or presence of the barrier resin in the preform for purposes of quality control.

Various systems for barrier detection devices are known in the prior art, but all are done either off-line, out of the manufacturing process, or in a lab environment. These barrier detection systems are very labor intensive, time consuming, and some are destructive to the PET preform. This is especially the case when, for example, the PET preform is sliced in half and the core barrier material is measured mechanically. Such a method can result in higher production cost since it can be labor intensive and it renders the PET preform as scrap.

Another known system requires that the PET preform be submersed into a liquid medium while an ultra-sonic transducer “pings” designated areas on the PET preform and records the reflected sound waves for presence of core barrier material. In this method, the PET preforms are discarded and not returned into the manufacturing population, which again, is wasteful since said method yields scrap.

Since the prior art systems are off-line, the systems validate only a small percentage of the total production and lack a method for real time and on-line quality control of core barrier additive to the PET barrier bottle.

Further, there can be considerable lag time from a manual production quality audit and the recorded audit results. For example, a PET preform injection nozzle could become clogged while production of the preforms proceeds. An off-line manual quality audit, as described above, will not determine that a problem has occurred until a scheduled audit is conducted, which may be well after the clog occurs. Such a delay will yield a significant production run of defective PET preforms. Potentially thousands of other preforms will have passed through the manufacturing process prior to the detection of the clog. Thus, the whole lot must be scrapped, or in the worse case, faulty preforms make their way to the consumer.

### SUMMARY AND OBJECT OF THE INVENTION

The invention provides a method and system for the real time, inspection of container preforms having a core barrier material therein. The system is operable to inspect the preform during the production process of the preform (“on-line”). The system is comprised of a process computer and a display output. A beam generator is used to generate a focused beam onto the preform. The preform will refract the beam. The refracted beam will be read and recorded by an image capture device. The image capture device will transmit refractive data to the process computer. The system is able then to generate an image corresponding to the inspected preform and the data related to the core barrier material is graphically represented as an area preferably having a geometric shape. The system then applies a mathematical function to the area to generate output that can used by the user for inspection purposes.

It is the object of the present inventors to provide an on-line automated nondestructive PET barrier bottle preform inspection system that is able to inspect preforms at manufacturing speeds for immediate, real-time quality assurance.

It is a further object of the invention to reduce labor and materials costs in the inspection of preforms.

Other objects of the invention will become readily apparent to one of ordinary skill in the art upon reading the description of the invention.

### BRIEF DESCRIPTION OF THE DRAWINGS

FIG. 1 is a side elevational schematic view of the inspection system.

FIG. 2 is a top view of the inspection system.

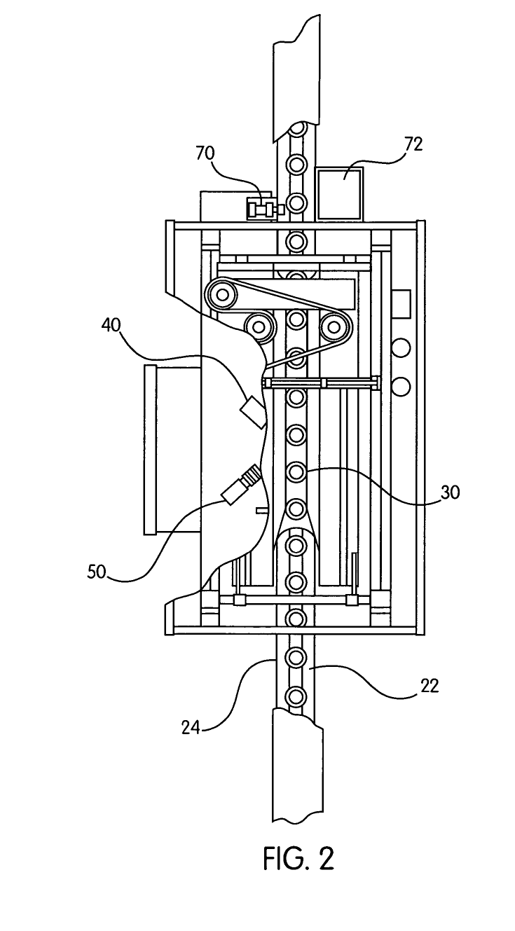

FIG. 3 is a perspective view of a preform being inspected.

FIGS. 4 and 5 are examples of inspection images generated by the system.

FIG. 6 is an alternative view of a preform being inspected.

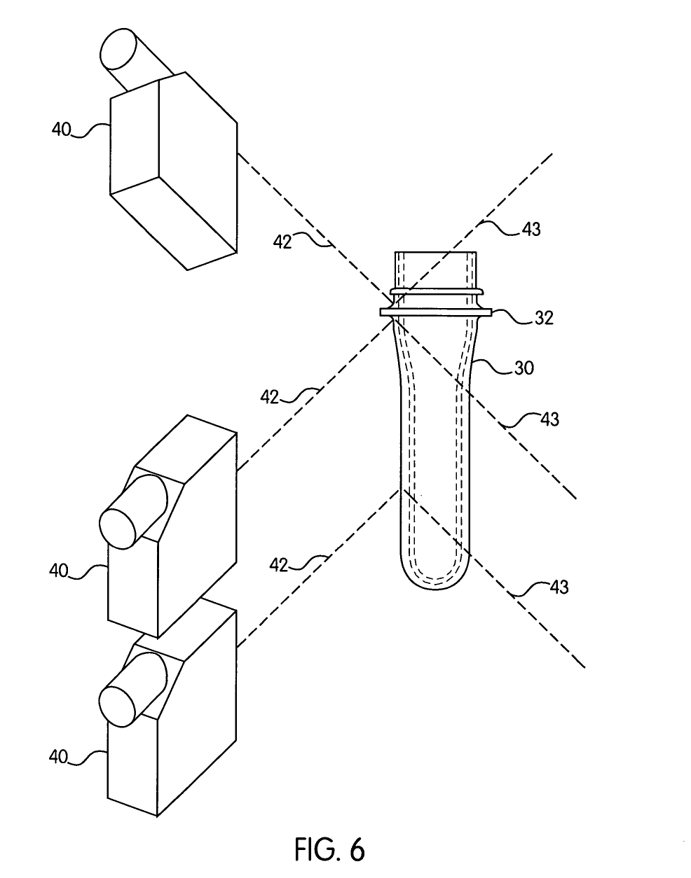

### DETAILED DESCRIPTION OF THE PREFERRED EMBODIMENT

The invention is a method and system for the real-time off-line detection of barrier core materials in container preforms. The invention provides a method and system for the inspection of container preforms designed for applications that require high levels of gas barrier to oxygen and carbon dioxide, for example, beverage bottles. The present invention automatically, nondestructively, noninvasively detects the presence and nature of multi-layer core barrier materials introduced during the injection molding of container preforms, for example PET barrier bottle preforms.

The present invention uses Snell's law in providing a nondestructive noninvasive automated optical inspection system. Generally, Snell's law states that refraction is the bending of the path of an electromagnetic wave as it passes across the boundary separating two media. Refraction is caused by a change in speed experienced by a wave when it changes medium. The inventive system and method is able to record the refractive signature (or refractive data) of an inspected object and process said data for on-line quality inspection data.

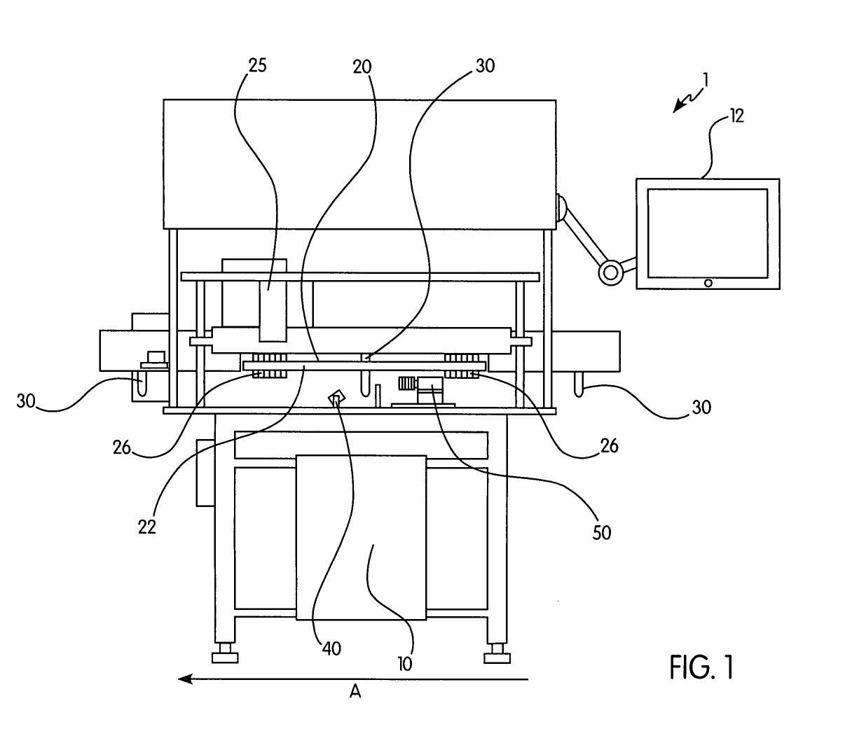

The inventive system 1 comprises a process computer generally and schematically depicted in FIG. 1 as 10. The process computer may comprise a microprocessor and memory storage. The system has display 12 for providing information to a user. Such process computers and displays are conventional and are readily available and known to those skilled in the art.

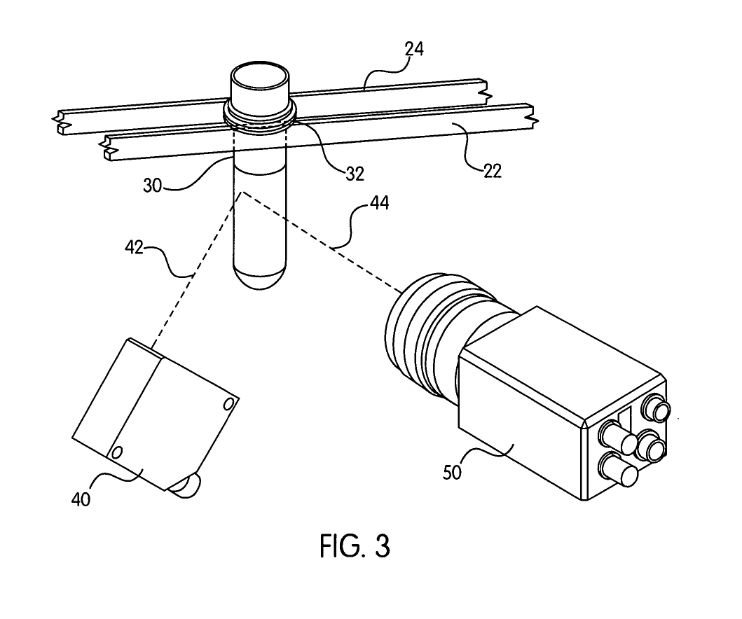

In one embodiment, a conveyor 20 is provided. Conveyors can be of conventional air type conveyors, belt type, or vacuum devices. Any conveying means can be used, however, the presently preferable conveyor comprises two continuos looped belts 22, 24. A motor 25 powers the gears, which engage each belt 22, 24 and cause each belt to rotate in opposite directions. In this embodiment, the preform 30 contains a ledge 32 (shown in FIG. 3). The preform is positioned between the belts 22, 24 and carried by the ledge 32 of the preform to an area where inspection takes place. In alternate embodiments, a conveyor is unnecessary. In such embodiments, the preform is positioned in the inspection area either manually, mechanically, robotically, or other similar means.

A beam generator 40 generates a focused beam 42 onto the preform 30 being inspected. Preferably, the beam generator 40 is positioned at angle of forty-five degrees from the preform being inspected 30. The beam generator 40 may be operated in a continuous or strobed basis as the preform 30 moves through the system. Preferably situated at another forty-five degrees from the preform being inspected is an image capture device 50, which in the presently preferred embodiment of the invention is a charged coupled device (“CCD”). The CCD is able to detect electromagnet energy outside the range of visible light. The image capture device 50 is coupled, preferably electrically, to the process computer 10 for capturing and storing images for storage and analysis in the memory storage of the process computer.

In an embodiment of the invention multiple narrow beams are projected along the side wall of the preform to cascade multiple geometric configurations throughout the object under inspection. The multiple geometric configurations along the entire side surface of the preform are viewed to verify complete internal barrier coverage and not just one area of the preform. Upon inspection, the beam 42 is refracted and reflected back to the image capture device 50. The image capture device 50 captures the refracted beam 44. Refractive data associated with each inspected preform is transmitted, stored, and processed by the process computer.

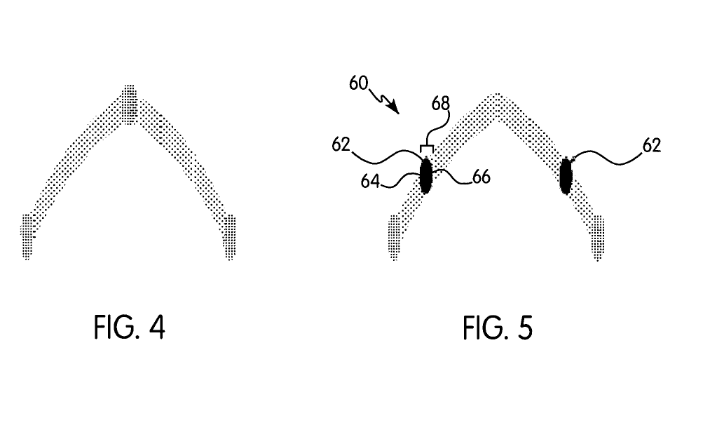

A set of instructions or a program, being executable by the process computer, processes said refractive data and provides an image respective of each inspected preform. Examples of such images are provided at FIGS. 4 and 5. FIG. 4 shows the refractive data of a preform having no core barrier material. FIG. 5 shows a preform having an intermediate core barrier layer. By way of example, the intermediate core barrier layer in FIG. 5 is seen as a darkened spot 62, which is a graphical depiction of a subset of the refractive data (“barrier data”) on the left side 60 of the “wishbone” image created by the system. After processing, the barrier data yields a particular geometric shape having edges that can be analyzed a number of ways. The edges of the spot represent the refraction points generated when the beam passes through the preform. It should be noted, however, that certain barrier materials may yield, after processing, the absence of a spot or a “lightened area”, which are also processed to form a geometric shape. Also, preforms having multiple layers of barrier material may yield multiple geometric shapes.

The optics are as follows. The beam generator 40 focuses a beam 42 that passes through the preform 30. The preform refracts the beam. The image capture device detects the refraction and integrates the refraction into refractive data that is sent to the process computer. As the beam traverses through the preform, it exhibits refraction densities due to the composition of material through which it passes. For example, when the beam gets to the barrier material, the diffusion of light (or other electromagnetic energy) caused by the barrier 62 can be more or less than the diffusion of light (or other electromagnetic energy) caused by the surrounding preform material, which creates an anomaly in the pattern of the beam. That anomaly is detected by the image capture device and processed by the process computer to generate a graphical depiction of the refractive data. For example, the graphical depiction generated is can be a “wishbone”. The “wishbone” can be lengthened or foreshortened by changing the angle of the beam entry point into the preform. The opposite leg of the wishbone is a reflection from the inside surface of the preform.

Preform material may be obstructed during the injection process and cause the core barrier material to drift off center and migrate to the outer or inner sidewall of the preform. The core barrier material may also shift in its elevation within the inner sidewall and drift toward the gate or finish of the preform. The core barrier material images generated by the system will provide images showing any anomalies in the symmetry of the geometric configuration refractive data of the preform that is being inspected as described below.

The refractive data for the inspected preform undergoes pre-processing to define selected geometric parameters associated with the inspected preform. For example, proprietary algorithms stored in memory are employed by the process computer to define, clarify, or enhance the edges of the graphically represented barrier data. Outlying data is also preferably processed and removed ultimately rendering barrier data having defined edges. FIG. 5 shows a preform wherein the side edges of the barrier data have been defined. In an embodiment of the invention, the distance 68 between the edges is measured. The edge to edge distance value is translated to “real” distance values based on predetermined relationships of real to “edge to edge” values stored in memory. The real distance, which is the thickness of the barrier material, is then displayed or otherwise communicated to the user of the system, or in alternate embodiments, compared against threshold values. If the distance is, for example, above a threshold value, the user is alerted. This allows the user to become aware of a defect in real-time while production of the preforms is taking place.

In alternate embodiments, the process computer executes a set of instructions to activate a rejection actuator to remove preforms having refractive data outside the threshold range, for example, by moving the defective preform into a rejection chute 72. This allows the defective preform to be removed from production on-line.

In alternate embodiments, the other mathematical functions can be applied to the barrier data to determine area, the distance between refraction points, the shape of the refraction geometry, the total area for shape/area analysis, and centroid of the refraction points. Threshold values can be compared to said geometric data and processed in much the same way as described above in order to determine the presence of and/or remove defective preforms.

In embodiments not connected with a conveyor device, the invention and its components can reside for example in a “table top” or handheld form, either being connected to the process computer (remotely or physically) or having the process computer integrated therein. In such a way, a user could preform spot inspections of preforms.

In another embodiment of the invention, the process computer program has a communications module for transmission of the information relating to the results of automated inspection to a remote location.

In another embodiment, after completion of the inspection cycle, the inspection results can provide a visual graphic 3D dimensional model of the preform with the core barrier mapped out and displayed on the user interface. A 3D dimension model may be enhanced with readily available software plug-ins.

While presently preferred embodiments have been described and shown, the invention may be otherwise embodied within the scope of the appended claims.

1. A system to optically inspect a container preform having core barrier material therein, the system operable to inspect the preform during the production process of the preform, the system comprising:
a. a storage medium to store instructions;
b. a beam generator operable to generate a focused beam onto said preform, the beam being refracted by the preform;
c. a conveyor to move said preforms within the beam;
d. an image capture device to capture the refracted beam and to transmit refractive data;
e. a processor to process said instructions and said refractive data to provide an image having the core barrier material graphically depicted, the processor processing said instructions to apply at least one mathematical function to the refractive data to generate output; and
f. an output display.

2. The system of claim 1 wherein the instructions are processed to determine the edges of said graphically depicted core barrier material and said mathematical function is to determine the distance between said edges.

3. The system of claim 1 wherein said core barrier material is graphically depicted as a defined geometric shape and said mathematical function is to determine the centroid of said shape.

4. The system of claim 1 wherein the beam generator is operable to generate a beam of any electromagnetic wavelength, wherein said beams are any one of continuous, pulsed, collimated, diffused, optically shaped, laser, polarized, or patterned.

5. The system of claim 1 wherein said conveyor comprises at least one belt.

6. The system of claim 1 wherein said conveyor is a vacuum conveyor.

7. The system of claim 1 further comprising a rejection actuator, said processor using said instructions and said output to actuate said rejection actuator.

8. The system of claim 1 wherein said output is transmitted to a remote location.

9. A method to optically inspect a container preform having a core barrier material therein, the steps comprising:
a. generating and focusing a beam of onto the preform, the preform refracting the beam;
b. capturing and recording refractive data respective to the preform;
c. providing a graphically represented image of the refractive data respective to the preform, the image defining an area corresponding to the core barrier material; and
d. applying a mathematical function to said area to generate inspection output data.

10. The method of claim 9 further comprising the steps of:
a. providing predetermined inspection threshold values; and
b. rejecting a preform having respective inspection output data that varies from said inspection threshold values.

11. The method of claim 9 wherein said mathematical function is to determine the distance between the side edges of said area.

12. The method of claim 9 wherein said mathematical function is to determine the center of said area.

13. A system to optically inspect a container preform having core barrier material therein, the system comprising:
a. a storage medium to store instructions;
b. a beam generator operable to generate a focused beam onto said preform, the beam being refracted by the preform;
c. an image capture device to capture the refracted beam and to transmit refractive data;
d. a processor to process said instructions and said refractive data to provide an image having the core barrier material graphically depicted, the processor processing said instructions to apply at least one mathematical function to the refractive data to generate output; and
e. an output display.

14. The system of claim 14 wherein the instructions are processed to determine the edges of said graphically depicted core barrier material and said mathematical function is to determine the distance between said edges.

15. The system of claim 14 wherein said core barrier material is graphically depicted as a defined geometric shape and said mathematical function is to determine the centroid of said shape.

16. The system of claim 14 wherein the beam generator is operable to generate a beam of any electromagnetic wavelength, wherein said beams are any one of continuous, pulsed, collimated, diffused, optically shaped, laser, polarized, or patterned.
